(19) United States
(12) Patent Application Publication
(10) Pub. No.: US 2025/0254333 A1
(43) Pub. Date: Aug. 7, 2025

(54) IMPLICIT INTRA MODE FOR COMBINED INTER MERGE/INTRA PREDICTION AND GEOMETRIC PARTITIONING MODE INTRA/INTER PREDICTION

(71) Applicant: InterDigital CE Patent Holdings, SAS, Paris (FR)

(72) Inventors: Philippe Bordes, Laille (FR); Ya Chen, Rennes (FR); Antoine Robert, Mézières sur Couesnon (FR); Franck Galpin, Thorigne-Fouillard (FR)

(73) Assignee: InterDigital CE Patent Holdings, SAS, Paris (FR)

(21) Appl. No.: 18/855,224

(22) PCT Filed: Apr. 6, 2023
(86) PCT No.: PCT/EP2023/059203

§ 371 Date: Oct. 8, 2024

(30) Foreign Application Priority Data
Apr. 8, 2022 (EP) 22305493.3

(51) Int. Cl. H04N 19/159; H04N 19/124; H04N 19/176; H04N 19/593

(52) U.S. Cl. CPC H04N 19/159; H04N 19/124; H04N 19/176; H04N 19/593

(57) ABSTRACT

A device may obtain a reference block associated with an inter prediction of a video block. The device may determine an intra-prediction mode associated with the video block based on one or more intra-prediction modes associated with the reference block. The device may decode or encode the video block based on the intra-prediction mode. In examples, the device may decode or encode the video block using an intra prediction and the inter prediction, and the intra prediction of the video block may be based on the intra-prediction mode. For example, combined intra-inter prediction (CIIP) may be enabled for the video block. CIIP for the video block may include the intra prediction of the video block and the inter prediction of the video block. The intra prediction of the video block may be based on the intra-prediction mode.

### CROSS-REFERENCE TO RELATED APPLICATIONS

This application claims priority to EP Provisional Patent Application No. 22305493.3, filed on Apr. 8, 2022, and entitled “Implicit Intra Mode for Combined Inter Merge/Intra Prediction and Geometric Partitioning Mode Intra/Inter Prediction,” the entirety of which is incorporated by reference as if fully set forth herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, methods, and instrumentalities are disclosed for determining an intra-prediction mode associated with a video block based on one or more intra-prediction modes associated with a reference block of the video block.

A device may obtain a reference block associated with an inter prediction of a video block. The device may determine an intra-prediction mode associated with the video block based on one or more intra-prediction modes associated with the reference block. The device may decode or encode the video block based on the intra-prediction mode. In examples, the device may decode or encode the video block using an intra prediction and the inter prediction, and the intra prediction of the video block may be based on the intra-prediction mode.

For example, combined intra-inter prediction (CIIP) may be enabled for the video block. CIIP for the video block may include the intra prediction of the video block and the inter prediction of the video block. The intra prediction of the video block may be based on the intra-prediction mode. The inter prediction of the video block may be based on a merge mode. A list of motion vector candidates may be associated with the merge mode. The device may determine a motion vector candidate based on the list of motion vector candidates, and the inter prediction of the video block may be based on the motion vector candidate. The motion vector candidate may be associated with another video block that is adjacent to the video block.

In some examples, geometric partitioning mode (GPM) may be enabled for the video block. GPM may include decoding or encoding a first portion of the video block using an intra-prediction mode and decoding or encoding a second portion of the video block using an inter-prediction mode. The first portion of the video block may be decoded or encoded using the intra-prediction mode that is determined based on the one or more intra-prediction modes associated with the reference block.

The one or more intra-prediction modes associated with the reference block may be stored, for example, in an intra-prediction mode buffer. The intra-prediction mode buffer may be associated with a reference picture that includes the reference block of the video block. The intra-prediction mode buffer may include one or more intra-prediction modes associated with the reference block, and the intra-prediction mode associated with the video block may be determined using the intra-prediction mode buffer. In examples, the reference block may include a reference sample. The one or more intra-prediction modes associated with the reference block may include an intra-prediction mode associated with the reference sample, and the intra-prediction mode associated with the video block may be determined based on the intra-prediction mode associated with the reference sample.

The device may determine an intra-prediction mode buffer of a plurality of intra-prediction mode buffers, for example, based on one or more of a type of intra-prediction mode associated with a reference picture associated with the intra-prediction mode buffer, a picture order count difference associated with the reference picture, and a quantization parameter associated with the reference picture, and the intra-prediction mode associated with the video block may be determined based on the determined intra-prediction mode buffer.

The reference block may be associated with multiple intra-prediction modes. In examples, the intra-prediction modes may include an intra-prediction mode associated with a pre-defined position in the reference block. The intra-prediction mode associated with the video block may be determined based on the intra-prediction mode associated with the pre-defined position in the reference block. The intra-prediction modes may include a dominant intra-prediction mode associated with the reference block, and the intra-prediction mode associated with the video block may be determined based on the dominant intra-prediction mode associated with the reference block. The dominant intra-prediction mode associated with the reference block may be an intra-prediction mode that is used to predict a majority of samples associated with the reference block.

The device may receive an indication associated with the intra prediction of the video block. The indication may indicate that the intra-prediction mode associated with the video block is to be determined based on the one or more intra-prediction modes associated with the reference block. The device may determine the intra-prediction mode associated with the video block based on the indication.

The reference block associated with the inter prediction of the video block may be obtained based on the reference picture that includes the reference block associated with the inter prediction of the video block. For example, the device may decode a reference picture associated with the video block, store the reference picture in a decoded picture buffer (DPB), retrieve the reference picture from the DPB, and obtain the reference block associated with the inter prediction of the video block using the reference picture retrieved from the DPB.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a system in which various aspects and examples may be implemented.

FIG. 5 illustrates an example of top and left neighboring blocks that may be used in combined inter and intra prediction (CIIP) weight derivation.

FIG. 6 illustrates an example of a position-dependent intra prediction combination weighting.

FIG. 7 illustrates an example of reference samples and template used for template-based intra mode derivation (TIMD).

FIG. 8 illustrates an example of a geometric partitioning mode (GPM) prediction.

FIG. 9 illustrates an example of a derivation of an intra mode for storage in a buffer (e.g., an IPM buffer) for blocks or CUs coded in an inter mode and/or the modified CIIP mode as shown in one or more examples herein.

FIG. 10 illustrates an example of the intra modes (e.g., all intra modes) stored in buffer(s) (e.g., IPM buffer(s)) for an area associated with a current block).

FIG. 11 illustrates an example of the intra modes coming from a buffer (e.g., the IPM buffers) on a 4×4 basis for an area covered by a block.

FIG. 12 illustrates an example of a CIIP mode that uses a planar intra-prediction mode and an inter-prediction mode.

FIG. 13 illustrates an example of a decoder or a decoding process that determines an intra-prediction mode associated with a coding block based on intra-prediction mode information of a reference picture (e.g., a reference block) associated with an inter-prediction mode.

FIG. 14 illustrates an example of an encoder or an encoding process that determines an intra-prediction mode associated with a coding block based on intra-prediction mode information of a reference picture (e.g., a reference block) associated with an inter-prediction mode.

FIG. 15 illustrates an example of a determination (e.g., by an encoder or a decoder) of an intra-prediction mode based on an intra-prediction mode associated with a reference block.

### DETAILED DESCRIPTION

A more detailed understanding may be had from the following description, given by way of example in conjunction with the accompanying drawings.

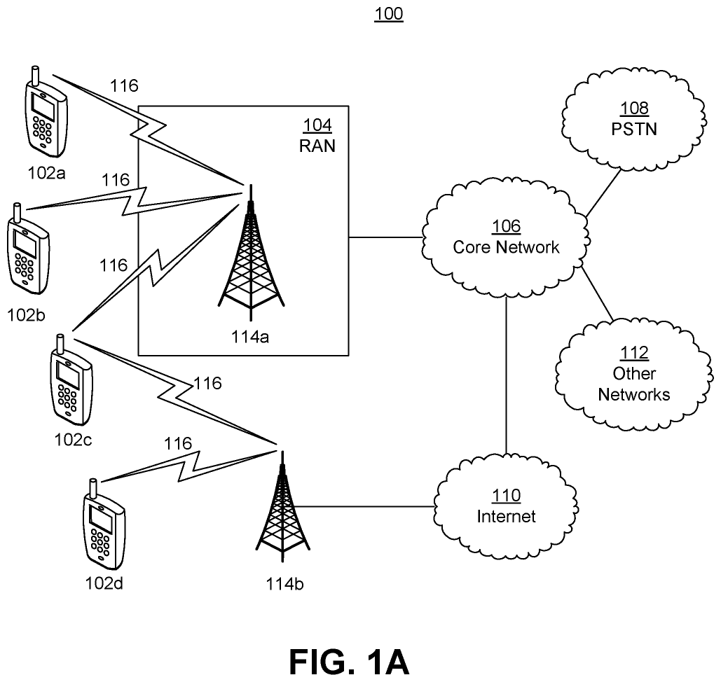

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA).

WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface.

The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

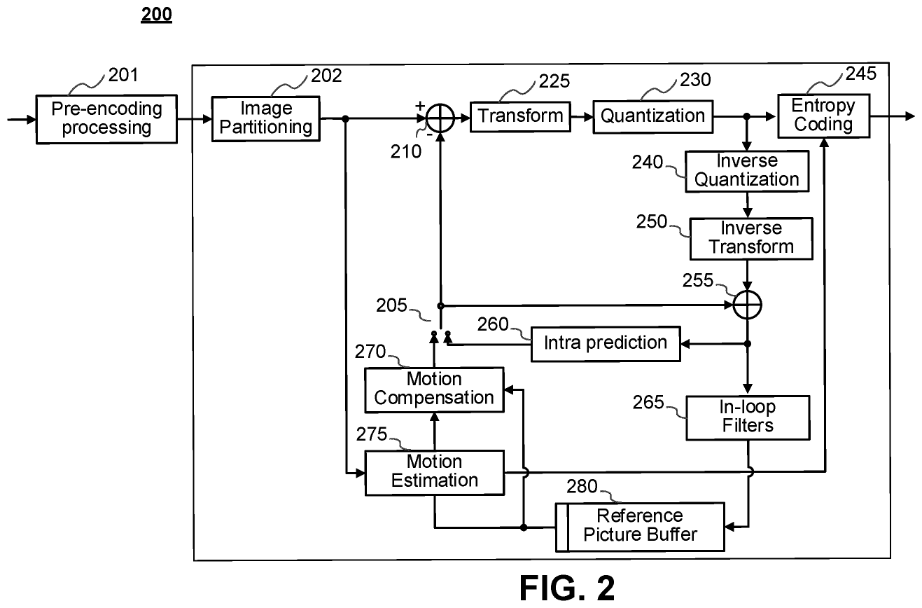

The aspects described and contemplated in this application may be implemented in many different forms. FIGS. 5-14 described herein may provide some examples, but other examples are contemplated. The discussion of FIGS. 5-14 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

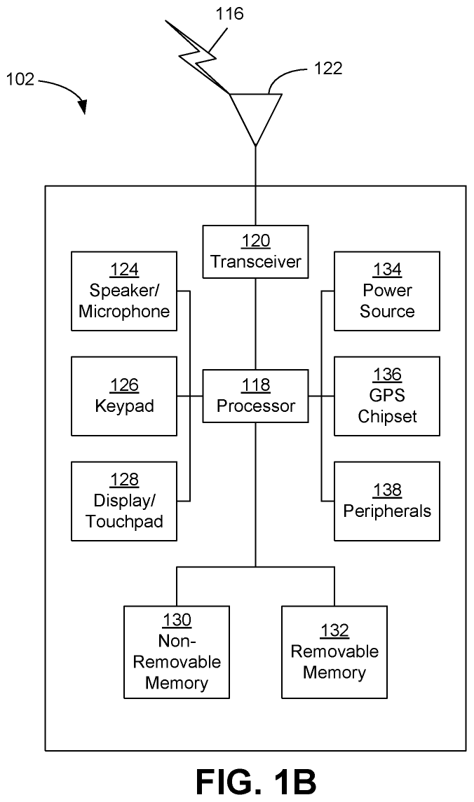

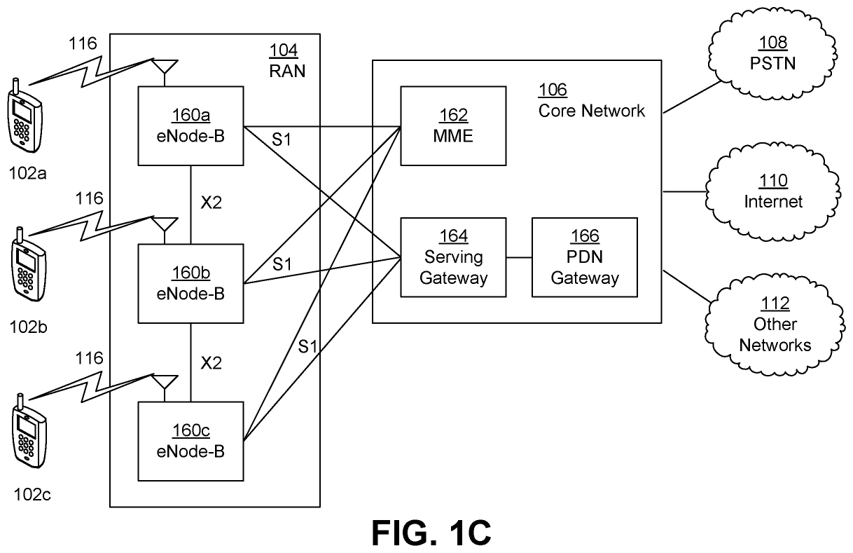

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application, such as 0, 1, 2, 34, 62, etc. These and other specific values are for purposes of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data. For example, the encoder 200 may perform one or more of the video decoding steps presented herein. The encoder reconstructs the decoded images, for example, to maintain synchronization with the decoder with respect to one or more of the following: reference pictures, entropy coding contexts, and other decoder-relevant state variables.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream. In an example, the decoded images (e.g., after application of the in-loop filters (365) and/or after post-decoding processing (385), if post-decoding processing is used) may be sent to a display device for rendering to a user.

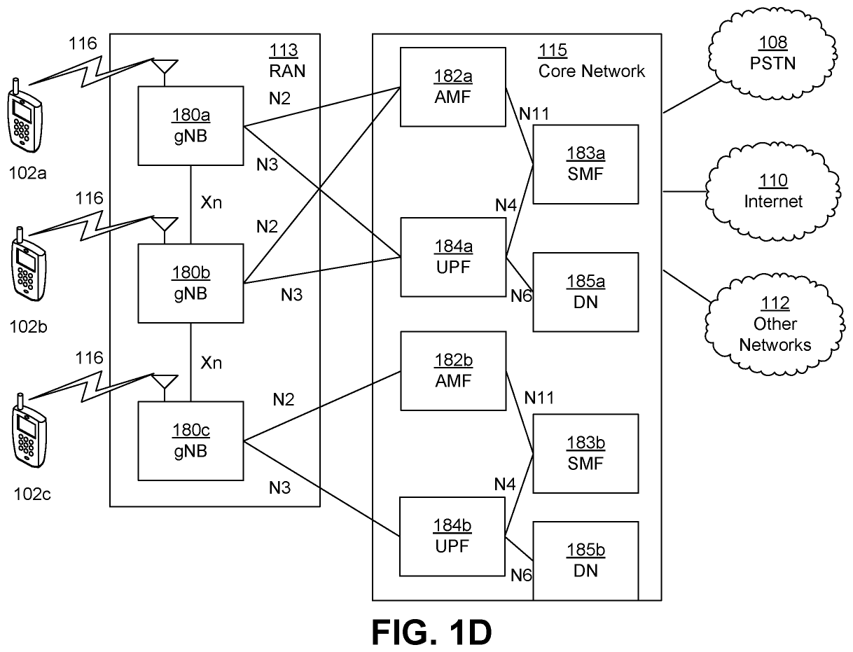

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth© network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, determining that a coding block is to be decoded using an intra-prediction mode and an inter-prediction mode, determining that the intra-prediction mode associated with the coding block based on intra-prediction mode information of a reference picture (e.g., a reference block) associated with the inter-prediction mode, decoding the coding block using the inter-prediction mode and the determined intra-prediction mode, obtaining a reference block associated with an inter prediction of a video block, determining an intra-prediction mode associated with the video block based on one or more intra-prediction modes associated with the reference block, decoding the video block using an intra prediction and the inter prediction, performing the intra prediction of the video block based on the determined intra-prediction mode, etc.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, determining that a coding block is to be encoded using an intra-prediction mode and an inter-prediction mode, determining that the intra-prediction mode associated with the coding block based on intra-prediction mode information of a reference picture (e.g., a reference block) associated with the inter-prediction mode, encoding the coding block using the inter-prediction mode and the determined intra-prediction mode, obtaining a reference block associated with an inter prediction of a video block, determining an intra-prediction mode associated with the video block based on one or more intra-prediction modes associated with the reference block, encoding the video block using an intra prediction and the inter prediction, performing the intra prediction of the video block based on the determined intra-prediction mode, etc.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, coding syntax on CIIP or GPM in the PPS, the PH, in the SPS, and/or in the block header, isIntraTop, isIntraLeft, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, coding syntax on CIIP or GPM in the PPS, the PH, in the SPS, and/or in the block header, an indication of whether a regular process or the intra mode derived from IPM buffer is to be used etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g. using a monitor, screen, or other type of display) a resulting image (e.g., an image from residual reconstruction of the video bitstream). The TV, set-top box, cell phone, tablet, or other electronic device may receive a signal including an encoded image and perform decoding.

Systems, methods, and instrumentalities are disclosed for determining a first prediction mode associated with a coding block based on prediction mode information of reference picture(s) (e.g., a reference block) associated with a second prediction mode. A device may be configured to determine that a coding block is to be encoded or decoded using a first prediction mode and a second prediction mode. The device may be configured to determine the first prediction mode associated with the coding block based on prediction mode information of reference picture(s) associated with the second prediction mode. The device may be configured to encode or decode the coding block using the second prediction mode and the determined first prediction mode.

In an example, the first prediction mode may be an intra-prediction mode. The second prediction mode may be an inter-prediction mode. The prediction mode information of the reference picture(s) associated with the second prediction mode may include intra-prediction mode information of the reference picture(s) (e.g., the reference block) associated with the second prediction mode. The intra-prediction mode information of the reference picture(s) may be stored in a buffer (e.g., an intra-prediction mode buffer) associated with the reference picture(s). The buffer may be a first intra-prediction mode buffer associated with a first reference picture (e.g., a first reference block). The device may be configured to determine the intra-prediction mode associated with the coding block further based on intra-prediction mode information stored in a second intra-prediction mode buffer. The second intra-prediction mode buffer may be associated with a second reference picture (e.g., a second reference block). The intra-prediction mode information of the reference picture(s) may include a plurality of intra-prediction modes. The device may be configured to determine the intra-prediction mode associated with the coding block based on an intra-prediction mode associated with a region of the coding block and/or of a region of a reference block of the coding block. In some examples, the device may be configured to determine the intra-prediction mode associated with the coding block using dominant intra-prediction mode of the plurality of intra-prediction modes. The dominant intra-prediction mode of the plurality of intra-prediction modes may be used to encode or decode a region of a reference block of the coding block that is bigger than other regions of the reference block. For example, each region of the reference block may be encoded or decoded using a different intra-prediction mode. The intra-prediction mode information of the reference picture(s) may indicate an intra-prediction mode used to decode the reference picture(s), and, if the inter-prediction mode used to encode or decode the coding block is uni-directional, the device may be configured to determine that the intra-prediction mode used to encode or decode the reference picture(s) is to be used as the intra-prediction mode used to encode or decode the coding block. If the inter-prediction mode used to encode or decode the coding block is bi-directional, the device may be configured to determine that the intra-prediction mode used to encode or decode the coding block further based on one or more parameters that are used to construct reference picture list(s). The reference picture list(s) may include one or more reference picture list 0 and reference picture list 1. In some examples, the device may be configured to receive an indication. The indication may indicate whether the intra-prediction mode used to decode the coding block is to be determined based on the intra-prediction mode information of the reference picture(s) associated with the inter-prediction mode, or the intra-prediction mode used to decode the coding block is to be a planar intra-prediction mode.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

Systems, methods, and instrumentalities are disclosed for determining an intra-prediction mode associated with a video block based on one or more intra-prediction modes associated with a reference block of the video block.

A device may obtain a reference block associated with an inter prediction of a video block. The device may determine an intra-prediction mode associated with the video block based on one or more intra-prediction modes associated with the reference block. The device may decode or encode the video block based on the intra-prediction mode. In examples, the device may decode or encode the video block using an intra prediction and the inter prediction, and the intra prediction of the video block may be based on the intra-prediction mode.

For example, combined intra-inter prediction (CIIP) may be enabled for the video block. CIIP for the video block may include the intra prediction of the video block and the inter prediction of the video block. The intra prediction of the video block may be based on the intra-prediction mode. The inter prediction of the video block may be based on a merge mode. A list of motion vector candidates may be associated with the merge mode. The device may determine a motion vector candidate based on the list of motion vector candidates, and the inter prediction of the video block may be based on the motion vector candidate. The motion vector candidate may be associated with another video block that is adjacent to the video block.

In some examples, geometric partitioning mode (GPM) may be enabled for the video block. GPM may include decoding or encoding a first portion of the video block using an intra-prediction mode and decoding or encoding a second portion of the video block using an inter-prediction mode. The first portion of the video block may be decoded or encoded using the intra-prediction mode that is determined based on the one or more intra-prediction modes associated with the reference block.

The one or more intra-prediction modes associated with the reference block may be stored, for example, in an intra-prediction mode buffer. The intra-prediction mode buffer may be associated with a reference picture that includes the reference block of the video block. The intra-prediction mode buffer may include one or more intra-prediction modes associated with the reference block, and the intra-prediction mode associated with the video block may be determined using the intra-prediction mode buffer. In examples, the reference block may include a reference sample. The one or more intra-prediction modes associated with the reference block may include an intra-prediction mode associated with the reference sample, and the intra-prediction mode associated with the video block may be determined based on the intra-prediction mode associated with the reference sample.

The device may determine an intra-prediction mode buffer of a plurality of intra-prediction mode buffers, for example, based on one or more of a type of intra-prediction mode associated with a reference picture associated with the intra-prediction mode buffer, a picture order count difference associated with the reference picture, and a quantization parameter associated with the reference picture, and the intra-prediction mode associated with the video block may be determined based on the determined intra-prediction mode buffer.

The reference block may be associated with multiple intra-prediction modes. In examples, the intra-prediction modes may include an intra-prediction mode associated with a pre-defined position in the reference block. The intra-prediction mode associated with the video block may be determined based on the intra-prediction mode associated with the pre-defined position in the reference block. The intra-prediction modes may include a dominant intra-prediction mode associated with the reference block, and the intra-prediction mode associated with the video block may be determined based on the dominant intra-prediction mode associated with the reference block. The dominant intra-prediction mode associated with the reference block may be an intra-prediction mode that is used to predict a majority of samples associated with the reference block.

The device may receive an indication associated with the intra prediction of the video block. The indication may indicate that the intra-prediction mode associated with the video block is to be determined based on the one or more intra-prediction modes associated with the reference block. The device may determine the intra-prediction mode associated with the video block based on the indication.

The reference block associated with the inter prediction of the video block may be obtained based on the reference picture that includes the reference block associated with the inter prediction of the video block. For example, the device may decode a reference picture associated with the video block, store the reference picture in a decoded picture buffer (DPB), retrieve the reference picture from the DPB, and obtain the reference block associated with the inter prediction of the video block using the reference picture retrieved from the DPB.

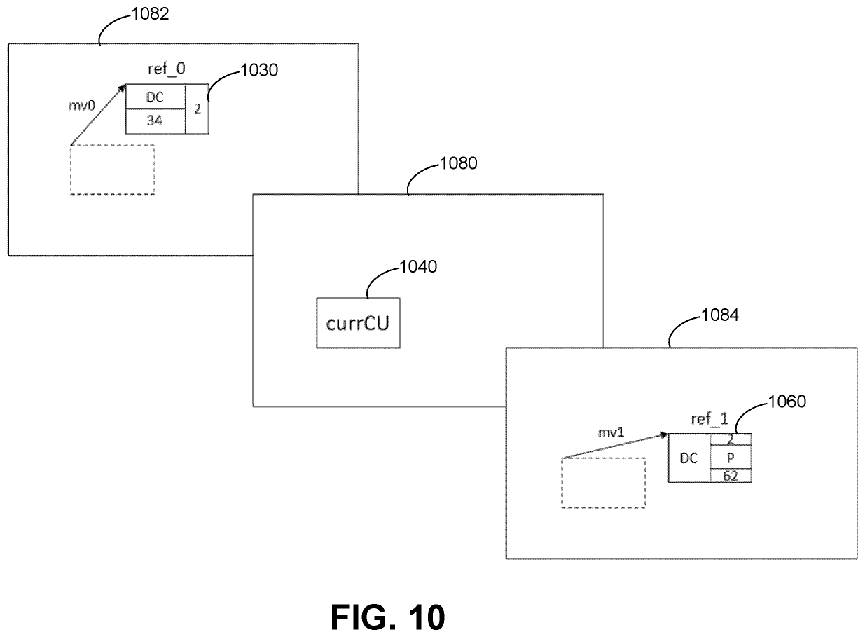

A combined inter and intra prediction (CIIP) mode may be used to code and/or decode a block. The block may include one or more CUs. A block may be a video block. The block may be a coding block. Whether the CIIP mode is applied to a block may be signaled, for example, in a video bitstream. For instance, when a block is coded using a merge mode, if the number of luma samples (for example, determined by block width times block height) in the block is equal to or above a threshold (for example, 64 luma samples) and if both the block width and block height are less than 128 luma samples, a flag may be signaled to indicate if the CIIP mode is applied to the block (for example, the current block). The CIIP prediction mode may combine an inter prediction signal with an intra prediction signal. FIG. 12 illustrates an example CIIP mode that uses a planar intra-prediction mode and an inter-prediction mode. The inter-prediction mode may be a regular inter-prediction mode or other inter-prediction modes. An inter prediction signal in the CIIP mode P_inter may be derived via a similar (for example, the same) inter prediction process as applied in a merge mode. In a merge mode, a list of motion vector candidates may be used by an encoder or a decoder to determine a motion vector candidate for the prediction of the inter prediction signal in the CIIP mode P_inter. The list of motion vector candidates may include motion vectors of blocks that are adjacent to the current block (e.g., a block on the top of the current block (the top neighboring block), a block on the left of the current block (the left neighboring block), etc.). The list of motion vector candidates may be built using motion vectors of neighboring reconstructed blocks (e.g., CUs) and/or temporal motion vector(s) (TMVP). The temporal motion vector(s) may include an MV of a block at the same position as the current block in a reference picture (e.g., one identified reference picture such as a collocated reference picture ColPic). For an inter prediction of CIIP, a block that is encoded or decoded using a merge mode may determine coding parameters (e.g., motion vector(s), reference ind(ices), bi-prediction weights, etc.) from a list of coding parameter candidates. An indication (e.g., an index) may be encoded or decoded to indicate which coding parameter candidate in the list of coding parameter candidates is to be used to reconstruct a current block. If the similar inter prediction process as applied in a merge mode is used, an MV may be inherited (e.g., the MV may have a non-integer value such as a sub-pel). An intra prediction signal in the CIIP mode P_intra may be derived following a similar (for example, the same) intra prediction process as applied in a regular intra mode (for example, the planar mode shown in FIG. 12) or TIMD. The intra and inter prediction signals may be combined, for example, using weighted averaging. The weight values applied during the combination may be calculated based on the coding modes of one or more neighboring blocks of a block (for example, a current block) such as the top and left neighboring blocks of the block (for example, the current block).

If a block (e.g., the current block) is encoded or decoded in a merge mode, if the block contains at least 64 luma samples (that is, block width times block height is equal to or larger than 64), and if both block width and block height are less than 128 luma samples, an additional flag may be signaled to indicate if the combined inter/intra prediction (CIIP) mode is applied to the block. The CIIP prediction may combine an inter prediction signal with an intra prediction signal. The inter prediction signal in the CIIP mode P_inter may be derived, for example, using the same inter prediction process applied to a regular merge mode. The intra prediction signal P_intra may be derived, for example, following the regular intra prediction process with a pre-defined intra mode (e.g., the planar mode). The intra and inter prediction signals may be combined using weighted averaging, where the weight value (wt) may be calculated depending on the coding modes of the top and left neighboring blocks (as depicted in FIG. 5).

FIG. 5 illustrates an example of top and left neighboring blocks that may be used in combined inter and intra prediction (CIIP) weight derivation. In the example shown in FIG. 5, CIIP weights may be derived using top and/or left neighboring blocks. If a top neighboring block is available and intra-coded, a flag or variable (for example, named “isIntraTop”) may be set to 1. Otherwise (for example, if no top neighboring block is available or intra-coded), the flag or variable (for example, “isIntraTop”) may be set to 0. If a left neighbor is available and intra-coded, a flag or variable (for example, named “isIntraLeft”) may be set to 1. Otherwise (for example, if no left neighboring block is available or intra-coded), the flag or variable (for example, “isIntraLeft”) may be set to 0. In examples, if the sum of the two variables or flags (isIntraTop+isIntraLeft) is equal to 2 (for example, if both of the top and the left neighbors are available and intra-coded), a CIIP weight may be set to 3. If the sum of the two variables or flags (isIntraTop+isIntraLeft) is equal to 1 (for example, if only one of the top or left neighbor is available and intra-coded), the CIIP weight may be set to 2. If the sum of the two variables or flags (isIntraTop+isIntraLeft) is equal to 0 (for example, if neither the top nor the left neighbor is available and intra-coded), the CIIP weight may be set to 1.

A CIIP prediction may be performed as shown in Formula (1).

$${P}_{CIIP} = ( ( 4 - wt ) * {P}_{inter} + wt * {P}_{intra} + 2 ) >> 2 \qquad ( 1 )$$

wherein wt represents the CIIP weight described herein, Pᵢₙₜₑᵣ represents an inter prediction signal and Pᵢₙₜᵣₐ represents an intra prediction signal.

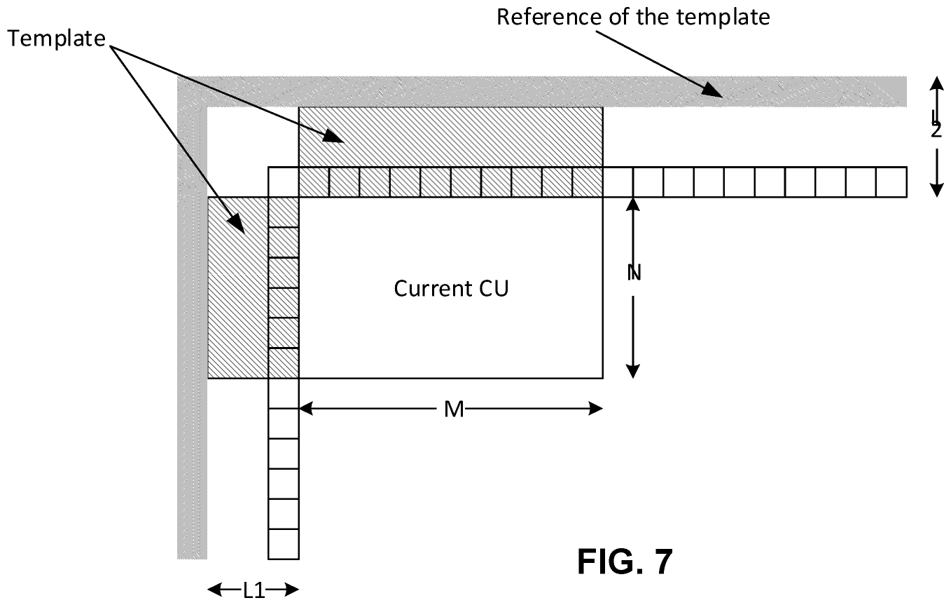

Intra mode propagation may occur, for example, as shown in FIG. 9.

One or more intra modes used to encode and/or decode blocks (e.g., an intra mode for a block) in intra prediction may be stored in a buffer (e.g., an intra-prediction mode (IPM) buffer). A buffer associated with a frame (e.g., the current frame) may be used to decode or encode subsequent frame(s). The one or more intra modes that are used to encode or decode blocks (e.g., reference blocks) in a reference picture may be stored, in the buffer, with information associated with a reference picture(s) (e.g., reference picture index), for example, in a similar manner as how the reference picture(s) is stored in a decoder picture buffer (DPB). An intra mode used to encode or decode a block of a picture may be stored in a buffer, for example, along with an associated with a location of the block in the picture. In examples, the location of the block in the picture may be collocated with a location of a current block that uses the block as a reference block. The block may be encoded or decoded using one or more intra modes. A location of a sample may be stored in the buffer with an intra mode used to encode or decode the sample. One or more intra modes used to decode some or all samples in the reference picture of the current picture may be made available for the current picture. In some examples, a reference block may be associated with a buffer (e.g., each reference block is associated with a respective IPM buffer).

A (e.g., each) reference picture may have one or more IPM buffers. For example, an IPM buffer of a reference picture may indicate an association of a location of a sample and an intra mode used to encode or decode the sample. For example, a map collocated with the reference sample(s) (e.g., a map associating an intra mode to each reference sample) may be included in the IPM buffer. An IPM buffer of a reference picture may be built as the reference picture is being encoded or decoded. The IPM buffer of the reference picture may be generated and/or available to be used to encode or decode a picture after the reference picture is encoded or decoded (e.g., after a completion of the encoding or decoding of the reference picture). For example, the IPM buffer associated with a current picture may be generated by including an intra mode used to encode or decode a current block of the picture or by including an intra mode that has been used to encode or decode a reference block of the current block and stored in an IPM buffer associated with a reference picture of the current picture. In examples, an IPM buffer (e.g., the IPM buffer of a current picture) may be filled, for example, during a reconstruction process (e.g., the reconstruction as part of a decoding process), for a block, using one or more of the following: the current intra mode (e.g., if an intra-prediction, for example, for CIIP or GPM, is used to decode (or encode) the current block); the intra mode that may be selected or read from the IPM buffer of the reference picture of the current picture (e.g., at the location of the reference sample(s) corresponding to the block). An IPM buffer may indicate an association of an intra mode and a location based on a resolution (e.g., 4×4 blocks, 8×8 blocks, etc. as a coding unit) of the reference picture. For example, a map associating the intra mode with the location may be associated with a resolution, and the resolution of the map may be reduced compared to the resolution of the reference picture. For example, some or all reference samples of a 4×4 window (e.g., a 4×4 block) may share the same IPM information. In examples, a size of an IPM buffer may be sub-sampled based on a size of a block or a picture. A (e.g., each) block of 4×4 samples may share the same IPM information.

FIG. 9 illustrates an example of a determination of an intra mode (e.g., by derivation). The determination of the intra mode may be for storage of the determined intra mode in a buffer (e.g., an IPM buffer), for example, for blocks (e.g., CUs) that are encoded or decoded using an inter prediction (e.g., in an inter mode and/or the modified CIIP mode as shown in one or more examples herein). In an example, the intra mode for the modified CIIP mode may be determined as shown in one or more examples herein (e.g., including the example shown in FIG. 9), and the intra mode for CIIP may be a planar intra-prediction mode or determined using TIMD. If the current block is coded (e.g., encoded or decoded) in an inter uni-directional mode, the intra mode associated with the reference block (e.g., available through the IPM buffer associated with the reference block) may be copied into the buffer (e.g., the IPM buffer) associated with the current block. The modified CIIP mode may include a prediction mode where an inter prediction signal is combined with an intra prediction signal (e.g., as combined in an CIIP mode) and where the intra prediction signal is generated based on one or more intra-prediction modes associated with a reference block, as described in one or more examples here.

FIG. 9 illustrates an example selection 500. If the current block is coded in an inter bi-prediction mode, one or more rules (510)-(570) may allow selecting one or more intra modes from the buffer (e.g., the IPM buffer) associated with the reference frame of list 0 (e.g., ipm0 from an IPM buffer associated with ref_0) or the reference frame of list 1 (e.g., ipm1 from an IPM buffer associated with ref_1). As shown in FIG. 9, at 510, a determination is made on whether ref_0 is coded in an intra mode and ref_1 is coded in inter mode. If ref_0 is coded in an intra mode and ref_1 is coded in inter mode, ipm0 may be selected. As shown in FIG. 9, at 520, a determination is made on whether ref_0 is coded in inter mode and ref_1 is coded in an intra mode, for example, if a determination is made at 510 that ref_0 is not coded in an intra mode or ref_1 is not coded in inter mode. If ref_0 is coded in inter mode and ref_1 coded in an intra mode, ipm1 may be selected. As shown in FIG. 9, at 530, a determination is made on whether ipm0>DC_IDX && ipm1<=DC_IDX, for example, if a determination is made at 520 that ref_0 is not coded in inter mode, or ref_1 not coded in an intra mode. For example, ipm0>DC_IDX && ipm1<=DC_IDX may indicate that ipm0 is associated with an intra mode index that is greater than an intra mode index of a DC mode, and ipm1 is associated with an intra mode index that is equal to or smaller than the intra mode index of a DC mode. If ipm0>DC_IDX && ipm1<=DC_IDX, ipm0 may be selected. As shown in FIG. 9, at 540, a determination is made on whether ipm0<=DC_IDX && ipm1>DC_IDX, for example, if a determination is made at 530 that ipm0>DC_IDX is not true or ipm1<=DC_IDX is not true. If ipm0<=DC_IDX && ipm1>DC_IDX, ipm1 may be selected. As shown in FIG. 9, at 550, a determination is made on whether pocDiff0<pocDiff1, for example, if a determination is made at 540 that ipm0<=DC_IDX is not true or ipm1>DC_IDX is not true. If pocDiff0<pocDiff1 is true, ipm0 may be selected. As shown in FIG. 9, at 560, a determination is made on whether pocDiff1<pocDiff0, for example, if a determination is made at 550 that pocDiff0<pocDiff1 is not true. If pocDiff1<pocDiff0, ipm1 may be selected.

As shown in FIG. 9, at 570, a determination is made on whether QP-ref0>QP-ref1, for example, if a determination is made at 560 that pocDiff1<pocDiff0 is not true. If QP-ref0>QP-ref1 is true, ipm1 may be selected. If QP-ref0>QP-ref1 is not true, ipm0 may be selected. The picture order count (POC) difference pocDiffX may be determined using pocDiffX=pocRefX−pocCur. pocDiff0 may indicate a POC difference between a current picture and a reference picture associated with reference list 0. pocDiff1 may indicate a POC difference between a current picture and a reference picture associated with reference list 1. DC_IDX may indicate the DC intra-prediction mode. QP-ref0 may indicate a quantization parameter used to encode or decode the reference picture associated with reference list 0. QP-ref1 may indicate a quantization parameter used to encode or decode the reference picture associated with reference list 1. Coding may include encoding or decoding.

Intra mode information (e.g., the determination of ipm0 or ipm1 in FIG. 9) may be propagated temporally and/or may be made available in association with some or all the reconstructed blocks (e.g., CUs). For the current blocks that are coded using intra mode(s) (e.g., the current blocks to be encoded or decoded using intra mode(s)), intra mode information associated with neighboring reconstructed blocks (e.g., CUs) may be used to build the list of most probable modes (MPM) for the current block(s), for example, even if the neighboring reconstructed blocks were coded using inter mode(s). The neighboring reconstructed blocks may include a block that has been reconstructed and is adjacent to the current block (e.g., a top neighbor or a left neighbor). For example, if a block neighbor of the current block is coded using an intra mode, the intra mode of the block neighbor may be used to build an MPM list for the current block. If a block neighbor is coded using an inter-mode, the intra mode stored in the IPM buffer associated with a reference block of the block neighbor (e.g., the reference block in a reference picture of the block neighbor) may be used to build the MPM list. In some examples, the intra mode stored in an IPM buffer of the block neighbor may be used to build the MPM list.

In one or more examples herein, the terms intra mode and intra-prediction mode may be used interchangeably. In one or more examples herein, the terms inter mode and inter-prediction mode may be used interchangeably. In one or more examples herein, the terms block and coding block may be used interchangeably. Intra-coded may refer to being decoded or encoded using an intra-prediction mode.

Fusion may be used for template-based intra mode derivation (TIMD).

TIMD may include testing multiple candidate intra-prediction modes in an MPM list on reconstructed pixels that are adjacent to a current block and selecting a candidate intra-prediction mode from the candidate intra-prediction modes based on the testing. In TIMD, intra-prediction modes may be tested on the template of reconstructed pixels (e.g., reconstructed pixels neighboring a current block). One or more candidate intra-prediction modes may be selected from the tested modes (e.g., based on the testing). For example, the two best modes may be selected (e.g., the modes which minimize the sum of absolute transform difference (SATD) between the template of reconstructed pixels and its prediction). The prediction signal may be generated from blending those two modes.

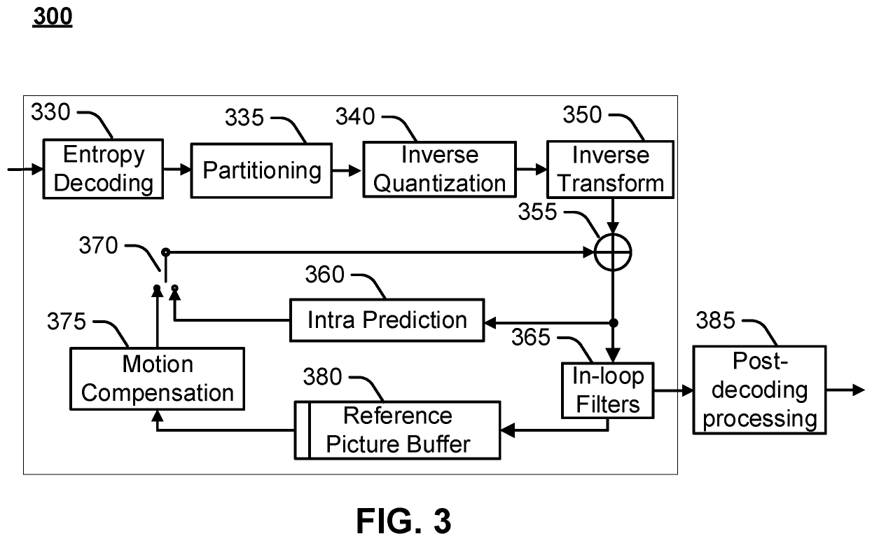

In some examples, the intra mode used to encode a block in a CIIP mode may be either planar (e.g., if the position dependent intra prediction combination process (PDPC) is also applied and signaled) or may be derived, for example, using a TIMD process as follows. In PDPC, the intra samples may be weighted with reference samples as illustrated in FIG. 6. FIG. 6 illustrates an example of a position-dependent intra prediction combination weighting.

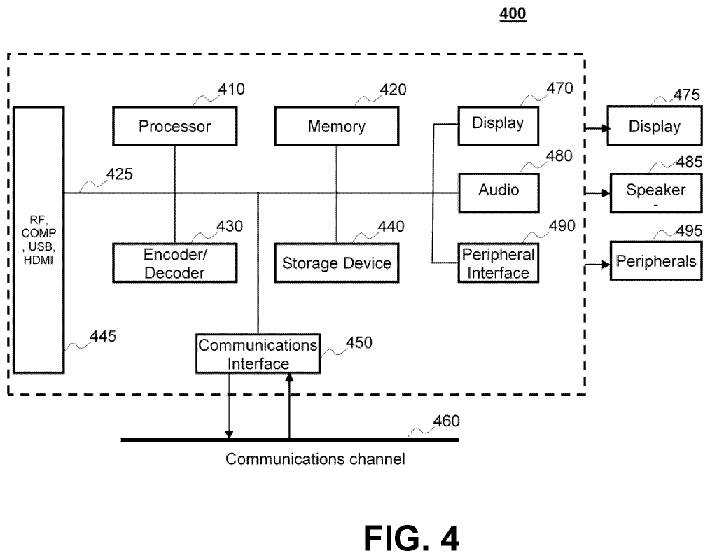

For an (e.g., each) intra-prediction mode in MPMs, the sum of absolute transformed differences (SATD) between the prediction samples and reconstruction samples of a template may be determined (e.g., by calculation), for example, as depicted in FIG. 7. FIG. 7 illustrates an example of reference samples and template used for TIMD. First two intra-prediction modes with the minimum SATD may be selected as the TIMD modes. These two TIMD modes may, for example, after applying a PDPC process, be fused with the weights, and such weighted intra prediction may be used to code the current block. PDPC may be used in a planar mode intra prediction and/or TIMD.

The costs of the two selected modes may be compared with a threshold, for example, using a test where the cost factor of 2 may be applied as follows:

$$costMode 2 < 2 * costMode 1 \qquad ( 2 )$$

If this condition (e.g., in formula (2)) is true, the fusion may be applied. If this condition (e.g., in formula (2)) is not true, the fusion may not be applied. For example, model 1 (e.g., only model) may be used.

Weights of the selected modes may be determined (e.g., through computation) from their SATD costs as shown in formula (3) and formula (4):

$$weight 1 = costMode 2 / ( costMode 1 + costMode 2 ) \qquad ( 3 )$$

$$weight 2 = 1 - weight 1 \qquad ( 4 )$$

The division operations may be conducted using an integerization scheme (e.g., the same lookup table (LUT) based integerization scheme used by the cross-component linear model (CCLM)).

Intra mode propagation may be applied for the geometric partitioning mode (GPM) with inter and intra prediction.

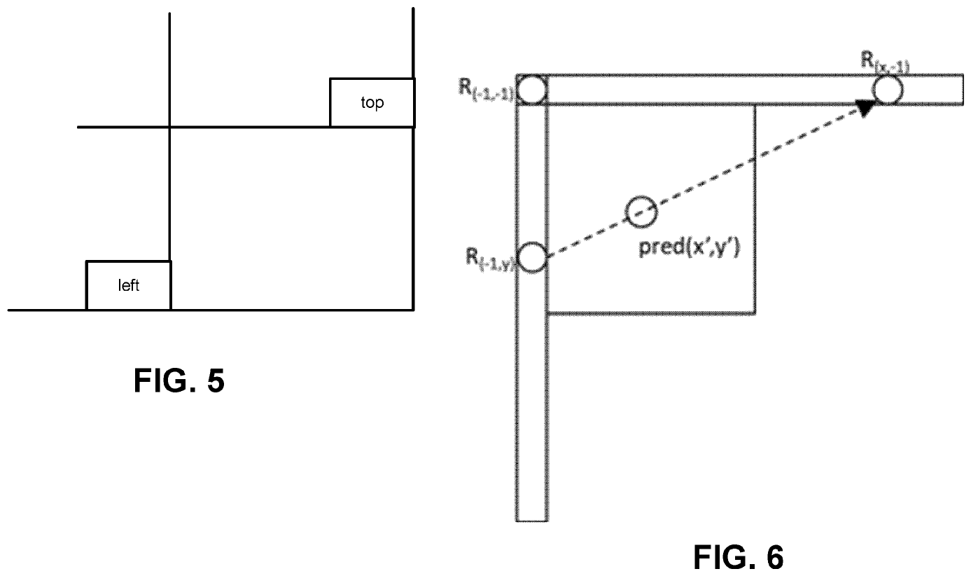

GPM may allow predicting a block with multiple partitions (e.g., predicting one block using two non-rectangular partitioning as depicted in some examples in FIG. 8). A partition (e.g., each partition) may be inter-predicted (e.g., as shown in 375 of FIG. 3) or intra-predicted (e.g., as shown in 360 of FIG. 3). The samples of the inter partition may be predicted with a regular inter prediction process, for example, using motion compensated reference samples picked from one (uni-prediction). FIG. 8 illustrates an example of a geometric partitioning mode (GPM) prediction. The samples of the intra partition may be predicted with a regular intra-prediction mode (IPM) and prediction process, where the available IPM candidates may be the angular mode parallel to the GPM block boundary (Parallel mode) as shown in FIG. 8(a), the perpendicular angular mode against the GPM block boundary (Perpendicular mode) as shown in FIG. 8(b), and the planar mode as shown FIG. 8(c), respectively. As shown in FIG. 8(d), in GPM, a partition may be encoded or decoded using an intra mode (e.g., Parallel mode), and another partition may be encoded or decoded using another intra mode (e.g., Perpendicular mode). The block boundary in GPM prediction may be the boundary of a partition (e.g., each partition in a block). The maximum number of merge candidates for GPM mode may be coded independently from the maximum number of merge candidates of the regular merge. The maximum number of merge candidates for GPM may be determined based on an indication in the PPS, the PH and/or in the SPS, or the like. The indication that indicates the maximum number of merge candidates for GPM may be or may include pic_five_minus_max_num_geo_cand, for example.

In some examples, a prediction mode (e.g., a CIIP mode) may use an intra-prediction mode (e.g., a pre-defined planar intra mode or a TIMD derived intra mode) for combining with an inter-prediction mode (e.g., a regular inter-prediction mode). In some examples, the planar intra mode may not adapt to the characteristics of a coding block (e.g., the current block). In some examples, TIMD may be a complex process to perform.

For a block (e.g., the current block) that is encoded or decoded using an inter prediction (e.g., at least part of the block is encoded or decoded using inter prediction), intra mode information of a reference block associated with the block (e.g., the intra mode information stored in a buffer such as an IPM buffer of the reference block associated with the block) may indicate signal characteristics of the block. A direction of an intra mode used to encode or decode the reference block of the block may indicate information about the spatial dominant gradient texture direction of the block. In one or more examples herein, the term “intra mode” and the term “intra-prediction mode” may be used interchangeably.

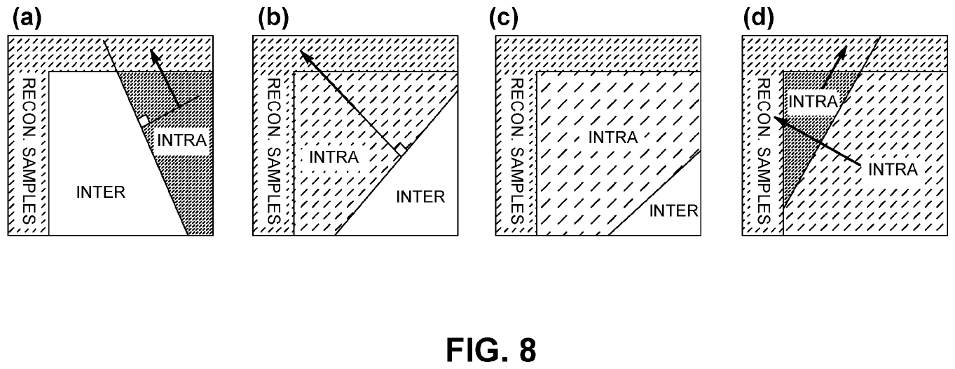

The intra-prediction mode information of the reference block may be used to determine (e.g., by derivation) the intra-prediction mode used to encode or decode a block (e.g., to generate an intra-prediction signal that is to be combined with an inter prediction signal in a CIIP mode). The intra-prediction mode information of the reference block may indicate one or more intra-prediction modes used to encode or decode the reference block. For example, as shown in FIG. 10, a reference block 1030 associated with a reference picture 1082 in reference list 0 (ref_0) may have been encoded or decoded using a DC intra-prediction mode, intra-prediction mode 2, and intra-prediction mode 34. In the example shown in FIG. 8, a reference block may have been encoded or decoded using GPM where the intra-prediction mode is an angular mode parallel to the GPM block boundary.

The reference block may be obtained based on a reference picture of the block. For example, the reference block may be associated with a first picture (e.g., the first picture may include the reference block). The first picture may be a reference picture of a second picture (e.g., the current picture). The block may be associated with the second picture. The reference block of the block may be obtained based on the first picture. The first picture may have been encoded or decoded. The first picture may have been stored, for example, in a reference picture buffer (e.g., a decoded picture buffer (DPB). To obtain the reference block of the block, the first picture may have been retrieved, and the reference block may be obtained based on the first picture.

The intra-prediction mode information of the reference block may be stored to be used to encode or decode subsequent picture(s). One or more parameters associated with the reference block may be stored to be used to encode or decode subsequent picture(s). The one or more parameters associated with the reference block may include the intra-prediction mode information of the reference block and/or inter-prediction mode information associated with the reference block. The inter-prediction mode information of the reference block may be used for the inter-prediction of the reference block and/or used for the inter-prediction of the block. The intra-prediction mode information of the reference block may include a parameter indicating an intra-prediction mode that has been used to encode or decode the reference block. The inter-prediction mode information associated with the reference block may include motion vector(s), reference ind(ices), and a parameter indicating a bi-prediction mode associated with the reference bock. The one or more parameters associated with the reference block may include a parameter indicating an IBC, palette prediction mode, etc.

The intra mode that is to be used to encode or decode a block (e.g., to generate an intra prediction signal that is to be combined with an inter prediction signal, for example, in case of CIIP) may be determined (e.g., by derivation) based on information from a buffer. For example, the intra mode information of the reference block may be stored in an IPM buffer. An IPM buffer may be associated with a picture (e.g., an encoded or decoded picture that may be used as a reference picture for a current block). The IPM buffer associated with the picture may be built as the picture is encoded or decoded. A picture (e.g., a current picture), the entirety of which is yet to be encoded or decoded, may be associated with a corresponding IPM buffer that is filled progressively as blocks of the picture are reconstructed. An IPM buffer may be used to facilitate an access to intra-prediction mode information of the reference block.

For a block that is encoded or decoded using an inter prediction and an intra prediction, the intra-prediction mode used to encode or decode the block may be determined based on the intra-prediction mode of a reference block. In case of CIIP and/or a modified CIIP, the intra mode used to generate the intra-prediction signal of a current block may be derived from the IPM buffer(s) of reference block(s) of the current block (e.g., the reference block that is used for the inter prediction of the current block), using same or similar rules as described in FIG. 9, for example. A fixed pre-determined intra mode may not be used. The intra prediction for the block may be improved. TIMD may not be used. Complexity may be reduced.

In some examples, inter prediction samples may be used to estimate the intra mode that is to be used to decode or encode at least a part of a block, for example, in case of CIIP and/or GPM intra/inter modes.

The intra mode that is to be used to encode or decode a block (e.g., to generate an intra prediction signal that is to be combined with an inter prediction signal, for example, in case of CIIP) may be determined (e.g., by derivation) using the information stored in one or more IPM buffers associated with one or more reference frames that are used to encode or decode the block using inter prediction(s) (e.g., to generate an inter prediction signal that is to be combined with the intra prediction signal, for example, in case of CIIP).

In some examples, the intra mode that is to be used to encode or decode a block, for example, in case of CIIP and/or a modified CIIP, may be determined (e.g., by derivation) using the collocated information of the IPM buffer. The collocated information may include a collocated IPM buffer. The collocated IPM buffer may include the IPM buffer of the reference picture marked as “collocated reference picture”. In an example, the index of the collocated reference picture may be signaled at the picture header (PH) or slice header (SH). The collocated reference picture may be encoded or decoded using an intra-prediction mode, IBC, or palette prediction mode, etc.

If the inter prediction to be used to encode or decode a block (e.g., to generate the inter prediction signal such as P_inter) is inter uni-directional, the intra mode associated with the reference block (e.g., the intra mode available through the IPM buffer associated with the reference block) may be used (e.g., directly used) as the intra mode that is to be used to decode or encode the block (e.g., to generate the intra prediction signal such as P_intra).

If the inter prediction to be used to encode or decode a block (e.g., to generate the inter prediction signal such as P_inter) is inter bi-directional, the intra mode that is to be used to decode or encode the block (e.g., to generate the intra prediction signal such as P_intra) may be determined using coding parameters associated with at least one reference picture list, for example, in addition to the information stored in one or more IPM buffer associated with the reference frame(s) that are used to encode or decode the block. The coding parameters may include one or more of a type of prediction mode (e.g., an inter-prediction mode or an intra-prediction mode) associated with a reference picture (e.g., a reference picture associated with reference picture list 0 or a reference picture associated with reference picture list 1); a type of intra-prediction mode (e.g., a DC intra-prediction mode, a planar intra-prediction mode, or angular intra-prediction mode(s)) associated with the reference picture; a POC difference associated with the reference picture; a quantization parameter associated with the reference picture.

For example, the intra mode that is to be used to decode or encode the block (e.g., to generate P_intra) may be selected from a first intra-prediction mode associated with a reference block of a reference frame of a reference picture list 0 (e.g., ipm0 shown in FIG. 9) and a second intra-prediction mode associated with a reference block of a reference frame of a reference picture list 1 (e.g., ipm1 shown in FIG. 9). The selection (e.g., through derivation) of the first intra-prediction mode (e.g., ipm0) or the second intra-prediction mode (e.g., ipm1) may be based on the coding parameter(s) associated with at least one reference picture list, for example, as described herein. The coding parameter(s) associated with at least one reference picture list (e.g., the coding parameter(s) associated with of the ref_0 and/or ref_1 predictions) may include one or more coding parameters in FIG. 9. For example, the one or more rules shown in FIG. 9 may be used to determine an intra mode that is to be used to decode or encode the block (e.g., according to the logic for propagating IPM(s) for inter-coded CUs, as depicted in example 500 shown in FIG. 9).

In some examples, if the inter prediction to be used to encode or decode a block (e.g., to generate P_inter) is inter bi-directional, and if a difference between the intra modes in the IPM buffer(s) (e.g., ipm0 and ipm1) is equal to or greater than a value, a pre-determined intra mode (e.g., a planar intra-prediction mode) may be used to decode or encode the block (e.g., to generate P_intra). A difference between the intra modes in the IPM buffer(s) may be determined based on the first intra-prediction mode associated with the reference block of the reference frame of a reference picture list 0 (e.g., ipm0) and the second intra-prediction mode associated with the reference block of the reference frame of a reference picture list 1 (e.g., ipm1). In examples, the difference between the intra modes in the IPM buffer(s) may be determined using intra mode indices. For example, a difference between an intra-prediction mode 2 and an intra-prediction mode 24 may be determined to be 22.

Formula (5) is an example difference between the intra modes in the IPM buffer(s). In formula (5), an absolute difference between the intra modes in the IPM buffer(s) (e.g., ipm0 and ipm1) is equal to or greater than a threshold th. The threshold th may be a pre-determined threshold.

$$\vert ipm 0 - ipm 1 \vert >= th \qquad ( 5 )$$

The value of the threshold th may be, for example, pre-defined and/or fixed for some or all sequences. The value of the threshold th may be signaled in a header (e.g., a sequence parameter set (SPS) header, a video parameter set (VPS) header, a picture parameter set (PPS) header, a picture header, etc.).

The intra mode that is to be used to encode or decode of a block, for example, in case of CIIP and/or a modified CIIP, may be determined (e.g., by derivation) using multiple IPMs.

Some or all intra modes of IPM buffer(s) associated with a region covered by a block (e.g., the current block) may be considered. The information stored in a buffer (e.g., the IPM buffer) associated with a reference block (e.g., the reference block that covers the same or collocated area as the area covered by the current block) may include different intra modes. In case of bi-prediction, a block may be associated with two reference blocks (e.g., two regions of the reference blocks) and two reference IPM buffers, as depicted in FIG. 10. As shown in FIG. 10, a current block 1040 may be associated with a reference block 1030 and associated with a reference block 1060. The current block 1040 may be associated with a current picture 1080. The reference block 1030 may cover an area in a first reference picture 1082 (ref_0), which is the same size as an area covered by a block collocated with the current block, as shown in FIG. 10. The reference block 1060 may cover an area in a second reference picture 1084 (ref_1), which is the same size as an area covered by a block collocated with the current block, as shown in FIG. 10. The reference block 1030 may be associated with a first buffer (e.g., a first IPM buffer). The coding parameter(s) associated with the reference block 1030 may be stored, for example, in the first buffer. The coding parameter(s) associated with the reference block 1030 may include the intra-prediction modes used to encode or decode the reference block 1030. As shown in FIG. 10, the intra-prediction modes used to encode or decode the reference block 1030 may include a DC intra-prediction mode, an intra-prediction mode 34, and an intra-prediction mode 2. The reference block 1060 may be associated with a second buffer (e.g., a second IPM buffer). The coding parameter(s) associated with the reference block 1060 may be stored, for example, in the second buffer. The coding parameter(s) associated with the reference block 1060 may include the intra-prediction modes used to encode or decode the reference block 1060. As shown in FIG. 10, the intra-prediction modes used to encode or decode the reference block 1060 may include a DC intra-prediction mode, an intra-prediction mode 2, a planar intra-prediction mode, and an intra-prediction mode 62.

The different intra modes may be obtained based on motion(s) and/or reference frame(s) to be used for the inter-prediction of the block 1040. As shown in FIG. 10, the reference block 1030 may be part of the first reference picture 1082 of reference picture list 0 (ref_0). The reference block 1030 may be associated with a first motion vector (mv0). The reference block 1060 may be part of the second reference picture 1084 of reference picture list 1 (ref_1). The reference block 1060 may be associated with a second motion vector (mv1). For example, a device (e.g., an encoder or a decoder) may determine, based on ref_0 and mv0, the DC intra-prediction mode, the intra-prediction mode 34, and the intra-prediction mode 2, which are stored in the first buffer, for the intra-prediction mode for reconstructing the block 1040.

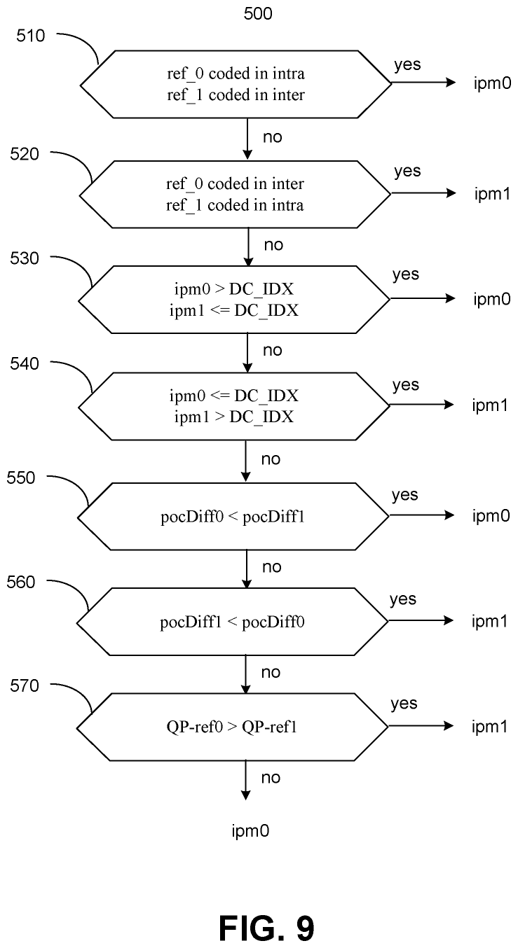

FIG. 10 illustrates an example of the intra modes (e.g., all intra modes) stored in buffer(s) (e.g., IPM buffer(s)) for an area associated with a current block. A corresponding area covered in the IPM buffer, for example, if the area of the block is large enough, may contain several intra modes (e.g., as shown in FIG. 11). As shown in FIG. 10, DC refers to a DC intra mode. 2, 34, and 62 are indices that indicate different intra modes. P refers to a planar intra mode.

An intra-prediction mode associated with a block may be determined based on the intra-prediction mode associated with a pre-defined position in the reference block of the current block. In examples, the stored IPM intra modes at a pre-defined region (e.g., a position such as the top-left position) associated with a block and/or a reference block of the block, may be selected. As shown in FIG. 10, the DC intra-prediction mode may be associated with a top left position of the reference block 1030, the intra-prediction mode 34 may be associated with a bottom left position of the reference block 1030, and the intra-prediction mode 2 may be associated with a top right position of the reference block 1030. The DC intra-prediction mode may be associated with a top left position of the reference block 1060, the intra-prediction mode 2 may be associated with a top right position of the reference block 1060, the planar intra-prediction mode may be associated with a middle right position of the reference block 1060, and the intra-prediction mode 62 may be associated with a bottom right position of the reference block 1060. If the top-left position (e.g., of the current block 1040 and/or of the reference block 1030) is selected as the pre-defined position, and ipm0 in FIG. 9 is determined to be the intra-prediction mode for the intra-prediction of the current block 1040, the DC intra-prediction mode may be determined to be the intra-prediction mode for the intra-prediction of the current block 1040. If the top-left position (e.g., of the current block 1040 and/or of the reference block 1030) is selected as the pre-defined position, and ipm1 in FIG. 9 is determined to be the intra-prediction mode for the intra-prediction of the current block 1040, the DC intra-prediction mode may be determined to be the intra-prediction mode for the intra-prediction of the current block 1040.

The reference block may be associated with multiple intra-prediction modes including an intra-prediction mode associated with a pre-defined position in the reference block. An intra-prediction mode associated with a block may be determined based on the intra-prediction mode associated with a pre-defined position in the reference block of the block.

An intra-prediction mode associated with a block may be determined based on the intra-prediction mode associated with the dominant intra-prediction mode associated with the reference block.

In an example, the intra mode that is to be used to encode or decode a block (e.g., the current block) may be a dominant intra-prediction mode. The dominant intra-prediction mode may include an intra-prediction mode that is associated with a region of the coding block whose size area_{dominant IPM}) is greater than a value or bigger than the sum of the size(s) of the other region(s) (area_{each other IPM}) of the coding block. The dominant intra-prediction mode may be observed over the surface(s) of the block projected into the reference frame and the reference IPM buffer(s). The dominant intra-prediction mode associated with the reference block may be an intra-prediction mode that is used to predict a majority of samples associated with the reference block. The dominant intra-prediction mode may be the mode which covers the largest area of the block under a condition (e.g., a weighting threshold “th” condition). An example of the condition is shown in formula (6).

$${area}_{dominant IPM} >= th * {area}_{each other IPM} \qquad ( 6 )$$

The value of the threshold th may be, for example, pre-defined and/or fixed for some or all sequences. The value of the threshold th may be signaled in a header (e.g., a sequence parameter set (SPS) header, a video parameter set (VPS) header, a picture parameter set (PPS) header, a picture header, etc.). The “th” in formula (6) may be used as a weighting factor for, for example, the sum of the areas associated with the IPM(s) that is not the dominant intra-prediction mode. For example, the sum of the areas associated with the IPM(s) may be a total area covered by samples that are encoded or decoded using IPM(s) other than the dominant intra-prediction mode. For example, in FIG. 10, the dominant intra-prediction mode for block 1030 may be determined to be a DC intra-prediction mode. In FIG. 11, if block 1106 is encoded or decoded using an intra-prediction mode 2, the dominant intra-prediction mode associated with block 1108 may be determined to be intra-prediction mode 2.

In the example shown in FIG. 10, the dominant intra-prediction mode may be set to be the DC intra mode if ipm 1 is determined to be the intra-prediction mode to be used to encode or decode the current block.

In some examples, if a dominant intra-prediction mode is not determined or cannot be determined, a default intra mode (e.g., the planar intra mode) may be used as the intra-prediction mode.

In some examples, the intra prediction (e.g., in the case of CIIP and/or a modified CIIP), may be performed on a 4×4 basis using different intra-prediction modes. Intra-prediction modes may be stored (e.g., in IPM buffer(s)) on a 4×4 basis. One or more rules for selecting an intra-prediction mode in FIG. 9 may be applied to determine an intra-prediction mode for a 4×4 block in FIG. 11. In some examples, for a 4×4 sub-part, if the first intra-prediction mode associated with the reference block of the reference frame of a reference picture list 0 (e.g., ipm0) is the same as the second intra-prediction mode associated with the reference block of the reference frame of a reference picture list 1 (e.g., ipm1), the first intra-prediction mode or the second intra-prediction mode may be used as the intra-prediction mode, for example, in the case of CIIP and/or a modified CIIP. For a 4×4 sub-part, if the first intra-prediction mode associated with the reference block of the reference frame of a reference picture list 0 (e.g., ipm0) is not the same as the second intra-prediction mode associated with the reference block of the reference frame of a reference picture list 1 (e.g., ipm1), an intra mode (e.g., a planar mode) may be used by default, for example, as shown on FIG. 11. FIG. 11 illustrates an example of the intra modes coming from a buffer (e.g., the IPM buffer(s)) on a 4×4 basis for an area covered by a block. As shown in FIG. 11, a 4×4 block 1104 may be encoded or decoded using the planar intra-prediction mode. For the block 1104, the first intra-prediction mode may not be the same as the second intra-prediction mode.

An indication (e.g., a flag) may be used to select the intra mode that is to be used to encode or decode a block, for example, in the case of CIIP and/or a modified CIIP.

In examples, an indication (e.g., a flag) may be coded (e.g., encoded or decoded) with a block that is coded in a CIIP mode to indicate whether the intra-prediction mode associated with the block is a regular process (e.g., a pre-determined intra mode such as a planar mode) or the intra-prediction mode associated with the block is to be determined based on the intra-prediction mode information associated with the reference picture (e.g., the reference block) of the block, as shown in one or more examples herein. For example, the indication may indicate that the intra-prediction mode associated with the video block is to be determined based on an intra-prediction mode buffer.

In some examples, the indication may be inherited from a block that is adjacent to the current block (e.g., the current block's neighboring candidate if it's available, such as a neighboring candidate used in association with a merge mode).

Inter prediction samples may be used to select the intra mode that is to be used to encode or decode a block, for example, in the case of CIIP and/or a modified CIIP.

In some examples, the intra mode that is to be used to encode or decode a block (e.g., the current block) may be determined based on the reconstructed inter prediction samples (e.g., the inter prediction samples that are used as a reference template). A set of intra mode candidates may be evaluated, for example, by computing the cost of the (e.g., each) intra mode of the set of intra mode candidates compared with the inter prediction samples. The cost may be computed, for example, using SATD as a cost function. In examples, the cost may be calculated on a sub-part of the block. In examples, the intra mode candidates may be re-ordered based on the corresponding cost, and an index may be coded (e.g., encoded or decoded) to indicate which intra mode candidate to use. In some examples, the intra mode candidate associated with the minimal cost may be selected (e.g., an index may not be coded).

Inter prediction samples may be used to select the intra mode that is to be used to encode or decode a portion (e.g., a first partition) of a block, for example, in the case of GPM intra/inter. In some examples, the intra mode that is to be used to encode or decode a portion (e.g., a first partition) of a block (e.g., the current block) may be determined based on the reconstructed inter prediction samples (e.g., the inter prediction samples that are used as a reference template). A set of intra mode candidates may be evaluated, for example, by computing the cost of the (e.g., each) intra mode of the set of intra mode candidates compared with the inter prediction samples. The cost may be computed, for example, using SATD as a cost function. The inter prediction samples may be determined based on the entirety of the block. The cost function may be performed on the portion that is to be encoded or decoded using the intra prediction (e.g., only the portion that is to be encoded or decoded using the intra prediction). In examples, the cost may be calculated on a sub-part of the block. The sub-part of the block may be from the portion that is to be encoded or decoded using the intra prediction, or from the portion that is to be encoded or decoded using an inter prediction, or from the portion that is to be encoded or decoded using the intra prediction and the portion that is to be encoded or decoded using the inter prediction. In examples, the intra mode candidates may be re-ordered based on the corresponding cost, and an index may be coded (e.g., encoded or decoded) to indicate which intra mode candidate to use. In some examples, the intra mode candidate associated with the minimal cost may be selected (e.g., an index may not be coded).

A decoder (e.g., the example decoder 300) may determine a first prediction mode associated with a coding block based on prediction mode information of reference picture(s) (e.g., reference block(s)) associated with a second prediction mode. A decoder may be configured to determine that a coding block is to be decoded using a first prediction mode and a second prediction mode. The decoder may be configured to determine the first prediction mode associated with the coding block based on prediction mode information of reference picture(s) associated with the second prediction mode. The decoder may be configured to decode the coding block using the second prediction mode and the determined first prediction mode. In examples, the decoder may obtain a reference block associated with an inter prediction of a video block. The decoder may determine an intra-prediction mode associated with the video block based on one or more intra-prediction modes associated with the reference block. The decoder may decode or encode the video block based on the intra-prediction mode. In examples, the decoder may decode the video block using an intra prediction and the inter prediction, and the intra prediction of the video block may be based on the intra-prediction mode.

In an example, the first prediction mode may be an intra-prediction mode. The second prediction mode may be an inter-prediction mode. The prediction mode information of the reference picture(s) (e.g., the reference block(s)) associated with the second prediction mode may include intra-prediction mode information of the reference picture(s) (e.g., the reference block(s)) associated with the second prediction mode. The intra-prediction mode information of the reference picture(s) associated with the second prediction mode may include the coding parameter associated with at least one reference picture list. The intra-prediction mode information of the reference picture(s) may be stored in a buffer (e.g., an intra-prediction mode buffer) associated with the reference picture(s). The buffer may be a first intra-prediction mode buffer associated with a first reference picture (e.g., a first reference block). The decoder may be configured to determine the intra-prediction mode associated with the coding block further based on intra-prediction mode information stored in a second intra-prediction mode buffer. The second intra-prediction mode buffer may be associated with a second reference picture (e.g., a second reference block). The intra-prediction mode information of the reference picture(s) may include a plurality of intra-prediction modes. The decoder may be configured to determine the intra-prediction mode associated with the coding block based on an intra-prediction mode associated with a region of the coding block and/or of a region of a reference block of the coding block. In some examples, the decoder may be configured to determine the intra-prediction mode associated with the coding block using a dominant intra-prediction mode of the plurality of intra-prediction modes. The dominant intra-prediction mode of the plurality of intra-prediction modes may be used to decode a region of a reference block of the coding block that is bigger than other regions of the reference block. For example, each region of the reference block may be decoded using a different intra-prediction mode. The intra-prediction mode information of the reference picture(s) may indicate an intra-prediction mode used to decode the reference picture(s), and, if the inter-prediction mode used to decode the coding block is uni-directional, the decoder may be configured to determine that the intra-prediction mode used to decode the reference picture(s) is to be used as the intra-prediction mode used to decode the coding block. If the inter-prediction mode used to decode the coding block is bi-directional, the decoder may be configured to determine that the intra-prediction mode used to decode the coding block further based on one or more parameters that are used to construct reference picture list(s) (e.g., a type of intra-prediction mode associated with the reference picture, a picture order count difference associated with the reference picture, and a quantization parameter associated with the reference picture). The reference picture list(s) may include one or more reference picture list 0 and reference picture list 1. In some examples, the decoder may be configured to receive an indication. The indication may indicate whether the intra-prediction mode used to decode the coding block is to be determined based on the intra-prediction mode information of the reference picture(s) associated with the inter-prediction mode, or the intra-prediction mode used to decode the coding block is to be a planar intra-prediction mode.

Decoding tools and techniques (e.g., as illustrated in FIG. 3) including, for example, one or more of entropy decoding, inverse quantization, inverse transformation, and differential decoding may be used to enable one or more examples as described herein in a decoder. For example, these decoding tools and techniques may be used to enable one or more of: determining an intra-prediction mode associated with a video block based on one or more intra-prediction modes associated with a reference block of the video block; obtaining a reference block associated with an inter prediction of a video block; determining an intra-prediction mode associated with the video block based on one or more intra-prediction modes associated with the reference block; decoding the video block based on the intra-prediction mode; decoding the video block using an intra prediction and the inter prediction, and the intra prediction of the video block may be based on the intra-prediction mode; determining that CIIP is enabled for the video block; determining a motion vector candidate based on a list of motion vector candidates, and the inter prediction of the video block may be based on the motion vector candidate; determining that GPM is enabled for the video block; storing the one or more intra-prediction modes associated with the reference block, for example, in an intra-prediction mode buffer; determining the intra-prediction mode associated with the video block using the intra-prediction mode buffer; determining the intra-prediction mode associated with the video block based on an intra-prediction mode associated with a reference sample of the reference block; determining an intra-prediction mode buffer of a plurality of intra-prediction mode buffers, for example, based on one or more of a type of intra-prediction mode associated with a reference picture associated with the intra-prediction mode buffer, a picture order count difference associated with the reference picture, and a quantization parameter associated with the reference picture; determining the intra-prediction mode associated with the video block based on an intra-prediction mode associated with a pre-defined position in the reference block; obtaining the reference block associated with the inter prediction of the video block based on the reference picture that includes the reference block associated with the inter prediction of the video block; decoding a reference picture associated with the video block; storing the reference picture in a DPB; retrieving the reference picture from the DPB; obtaining the reference block associated with the inter prediction of the video block using the reference picture retrieved from the DPB; obtaining a coding block; determining that the coding block is to be decoded using a first prediction mode (e.g., an intra-prediction mode, an inter-prediction mode, or others); determining that the coding block is to be decoded using a second prediction mode (e.g., an intra-prediction mode, an inter-prediction mode, or others); determining that the coding block is to be decoded using the first prediction mode and the second prediction mode; determining the first prediction mode associated with the coding block based on prediction mode information (e.g., intra-prediction mode information) of reference picture(s) (e.g., reference block(s)) associated with the second prediction mode; decoding the coding block using the determined first prediction mode; decoding the coding block using the second prediction mode; decoding the coding block using the second prediction mode and the determined first prediction mode; obtaining the prediction mode information of the reference picture(s) (e.g., the reference block(s)) stored in a buffer (e.g., an intra-prediction mode buffer) associated with the reference picture(s); determining the first prediction mode associated with the coding block further based on the prediction mode information stored in another buffer (e.g., another intra-prediction mode buffer); determining the first prediction mode associated with the coding block based on an intra-prediction mode associated with a region of the coding block and/or of a region of a reference block of the coding block; determining the first prediction mode associated with the coding block using a dominant intra-prediction mode of the plurality of intra-prediction modes; if the second prediction mode used to decode the coding block is uni-directional, determining that the prediction mode used to decode the reference picture(s) is to be used as the first prediction mode used to decode the coding block; if the second prediction mode used to decode the coding block is bi-directional, determining that the prediction mode used to decode the coding block further based on one or more parameters that are used to construct reference picture list(s); receiving an indications that indicate whether the first prediction mode used to decode the coding block is to be determined based on the prediction mode information of the reference picture(s) associated with the second prediction mode, or the first prediction mode used to decode the coding block is predefined or predetermined; generating a signal using the first prediction mode to decode at least a part of the block; generating a signal using the second prediction mode to decode at least a part of the block; combine the signal generated using the first prediction mode to decode at least a part of the block with the signal generated using the second prediction mode to decode at least a part of the block.

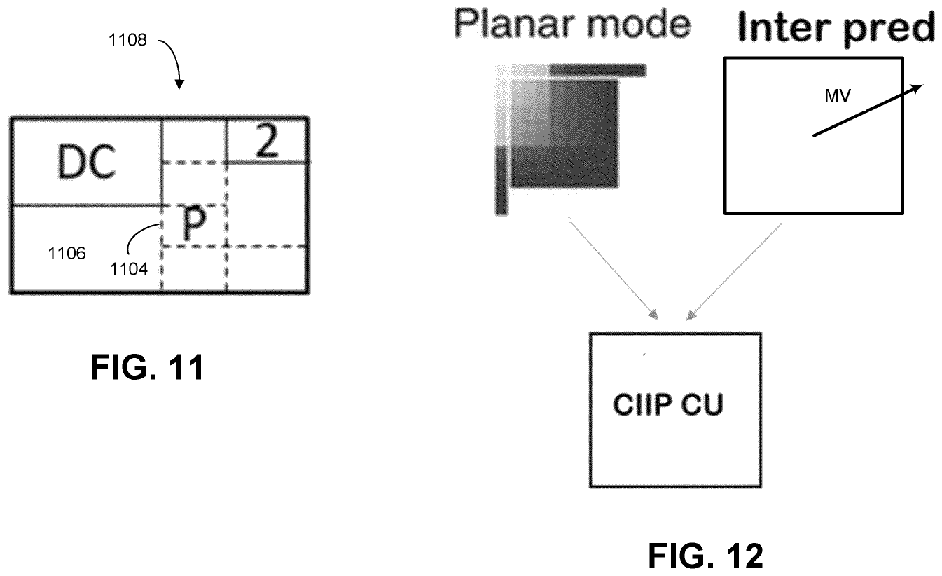

FIG. 13 illustrates an example of a decoder or a decoding process 1300 that determines an intra-prediction mode associated with a coding block based on intra-prediction mode information of a reference block associated with an inter-prediction mode. 1300 may be implemented by an apparatus as described herein including a decoder (such as example decoder 300), and the examples disclosed herein may operate in accordance with 1300 shown in FIG. 13. 1300 may comprise 1302, 1304 and 1306. At 1302, it is determined that a coding block is to be decoded using an intra-prediction mode (e.g., shown in 260 of FIGS. 2 and 360 of FIG. 3) and an inter-prediction mode (e.g., shown in 270 or 275 of FIGS. 2 and 375 of FIG. 3). At 1304, it is determined that the intra-prediction mode associated with the coding block based on intra-prediction mode information of a reference block associated with the inter-prediction mode. At 1306, the coding block is decoded using the inter-prediction mode and the determined intra-prediction mode. Decoding tools and techniques including one or more of entropy decoding, inverse quantization, inverse transformation, and differential decoding may be used to enable 1300 as described in FIG. 13 in the decoder.

An encoder (e.g., the example encoder 200) may determine a first prediction mode associated with a coding block based on prediction mode information of reference picture(s) (e.g., reference block(s)) associated with a second prediction mode. An encoder may be configured to determine that a coding block is to be encoded using a first prediction mode and a second prediction mode. The encoder may be configured to determine the first prediction mode associated with the coding block based on prediction mode information of reference picture(s) associated with the second prediction mode. The encoder may be configured to encode the coding block using the second prediction mode and the determined first prediction mode.

In an example, the first prediction mode may be an intra-prediction mode. The second prediction mode may be an inter-prediction mode. The prediction mode information of the reference picture(s) (e.g., reference block(s)) associated with the second prediction mode may include intra-prediction mode information of the reference picture(s) associated with the second prediction mode. The intra-prediction mode information of the reference picture(s) associated with the second prediction mode may include the coding parameter associated with at least one reference picture list. The intra-prediction mode information of the reference picture(s) may be stored in a buffer (e.g., an intra-prediction mode buffer) associated with the reference picture(s). The buffer may be a first intra-prediction mode buffer associated with a first reference picture (e.g., a first reference block). The encoder may be configured to determine the intra-prediction mode associated with the coding block further based on intra-prediction mode information stored in a second intra-prediction mode buffer. The second intra-prediction mode buffer may be associated with a second reference picture (e.g., a second reference block). The intra-prediction mode information of the reference picture(s) may include a plurality of intra-prediction modes. The encoder may be configured to determine the intra-prediction mode associated with the coding block based on an intra-prediction mode associated with a region of the coding block and/or of a region of a reference block of the coding block. In some examples, the encoder may be configured to determine the intra-prediction mode associated with the coding block using dominant intra-prediction mode of the plurality of intra-prediction modes. The dominant intra-prediction mode of the plurality of intra-prediction modes may be used to encode a region of a reference block of the coding block that is bigger than other regions of the reference block. For example, each region of the reference block may be encoded using a different intra-prediction mode. The intra-prediction mode information of the reference picture(s) may indicate an intra-prediction mode used to encode the reference picture(s), and, if the inter-prediction mode used to encode the coding block is uni-directional, the encoder may be configured to determine that the intra-prediction mode used to encode the reference picture(s) is to be used as the intra-prediction mode used to encode the coding block. If the inter-prediction mode used to encode the coding block is bi-directional, the encoder may be configured to determine that the intra-prediction mode used to encode the coding block further based on one or more parameters that are used to construct reference picture list(s) (e.g., a type of intra-prediction mode associated with the reference picture, a picture order count difference associated with the reference picture, and a quantization parameter associated with the reference picture). The reference picture list(s) may include one or more reference picture list 0 and reference picture list 1. In some examples, the encoder may be configured to send an indication. The indication may indicate whether the intra-prediction mode used to decode the coding block is to be determined based on the intra-prediction mode information of the reference picture(s) associated with the inter-prediction mode, or the intra-prediction mode used to decode the coding block is to be a planar intra-prediction mode.

Encoding tools and techniques (e.g., as illustrated in FIG. 2) including one or more of quantization, entropy coding, inverse quantization, inverse transformation, and differential coding may be used to enable one or more examples as described herein in the encoder. For example, these encoding tools and techniques may be used to enable one or more of: determining an intra-prediction mode associated with a video block based on one or more intra-prediction modes associated with a reference block of the video block; obtaining a reference block associated with an inter prediction of a video block; determining an intra-prediction mode associated with the video block based on one or more intra-prediction modes associated with the reference block; encoding the video block based on the intra-prediction mode; encoding the video block using an intra prediction and the inter prediction, and the intra prediction of the video block may be based on the intra-prediction mode; determining that CIIP is enabled for the video block; determining a motion vector candidate based on a list of motion vector candidates, and the inter prediction of the video block may be based on the motion vector candidate; determining that GPM is enabled for the video block; storing the one or more intra-prediction modes associated with the reference block, for example, in an intra-prediction mode buffer; determining the intra-prediction mode associated with the video block using the intra-prediction mode buffer; determining the intra-prediction mode associated with the video block based on an intra-prediction mode associated with a reference sample of the reference block; determining an intra-prediction mode buffer of a plurality of intra-prediction mode buffers, for example, based on one or more of a type of intra-prediction mode associated with a reference picture associated with the intra-prediction mode buffer, a picture order count difference associated with the reference picture, and a quantization parameter associated with the reference picture; determining the intra-prediction mode associated with the video block based on an intra-prediction mode associated with a pre-defined position in the reference block; obtaining the reference block associated with the inter prediction of the video block based on the reference picture that includes the reference block associated with the inter prediction of the video block; obtaining a coding block; determining that the coding block is to be encoded using a first prediction mode (e.g., an intra-prediction mode, an inter-prediction mode, or others); determining that the coding block is to be encoded using a second prediction mode (e.g., an intra-prediction mode, an inter-prediction mode, or others); determining that the coding block is to be encoded using the first prediction mode and the second prediction mode; determining the first prediction mode associated with the coding block based on prediction mode information (e.g., intra-prediction mode information) of reference picture(s) (e.g., reference block(s)) associated with the second prediction mode; encoding the coding block using the determined first prediction mode; encoding the coding block using the second prediction mode; encoding the coding block using the second prediction mode and the determined first prediction mode; obtaining the prediction mode information of the reference picture(s) (e.g., the reference block(s)) stored in a buffer (e.g., an intra-prediction mode buffer) associated with the reference picture(s); determining the first prediction mode associated with the coding block further based on the prediction mode information stored in another buffer (e.g., another intra-prediction mode buffer); determining the first prediction mode associated with the coding block based on an intra-prediction mode associated with a region of the coding block and/or of a region of a reference block of the coding block; determining the first prediction mode associated with the coding block using a dominant intra-prediction mode of the plurality of intra-prediction modes; if the second prediction mode used to encode the coding block is uni-directional, determining that the prediction mode used to encode the reference picture(s) is to be used as the first prediction mode used to encode the coding block; if the second prediction mode used to encode the coding block is bi-directional, determining that the prediction mode used to encode the coding block further based on one or more parameters that are used to construct reference picture list(s); sending an indications that indicate whether the first prediction mode used to encode the coding block is to be determined based on the prediction mode information of the reference picture(s) associated with the second prediction mode, or the first prediction mode used to encode the coding block is predefined or predetermined; generating a signal using the first prediction mode to encode at least a part of the block; generating a signal using the second prediction mode to encode at least a part of the block; combine the signal generated using the first prediction mode to encode at least a part of the block with the signal generated using the second prediction mode to encode at least a part of the block.

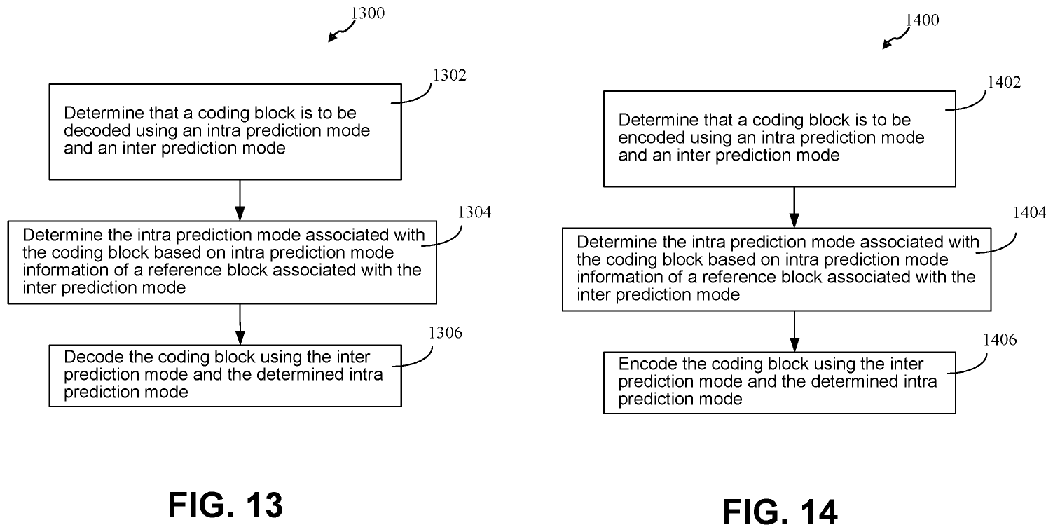

FIG. 14 illustrates an example of an encoder or an encoding process that determines an intra-prediction mode associated with a coding block based on intra-prediction mode information of a reference block associated with an inter-prediction mode. 1400 may be implemented by an apparatus as described herein including an encoder (such as example encoder 200), and the examples disclosed herein may operate in accordance with 1400 shown in FIG. 14. 1400 may comprise 1402, 1404 and 1406. At 1402, it is determined that a coding block is to be encoded using an intra-prediction mode (e.g., shown in 260 of FIGS. 2 and 360 of FIG. 3) and an inter-prediction mode (e.g., shown in 270 or 275 of FIGS. 2 and 375 of FIG. 3). At 1404, it is determined that the intra-prediction mode associated with the coding block based on intra-prediction mode information of a reference block associated with the inter-prediction mode. At 1406, the coding block is encoded using the inter-prediction mode and the determined intra-prediction mode. Encoding tools and techniques including one or more of quantization, entropy coding, inverse quantization, inverse transformation, and differential coding may be used to enable 1400 as described in FIG. 14 in the encoder.

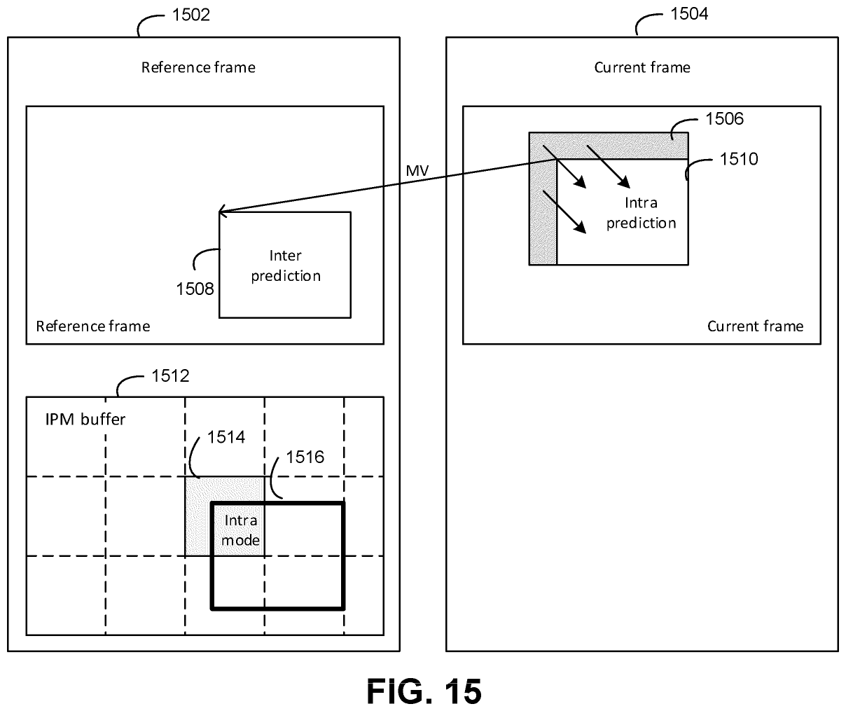

FIG. 15 illustrates an example of a determination (e.g., by an encoder or a decoder) of an intra-prediction mode based on an intra-prediction mode associated with a reference block. The current frame 1504 may include a block 1510 (e.g., as shown in FIG. 10, the current picture 1080 may include the current block 1040). The gray areas 1506 in FIG. 15 may refer to reference samples (e.g., reconstructed reference samples) associated with the block 1510. The current frame 1504 may be associated with a reference frame 1502 (e.g., as shown in FIG. 10, the current picture 1080 may be associated with a reference picture 1082). The block 1510 may be associated with a reference block 1508 (e.g., as shown in FIG. 10, the current block 1040 may be associated with a reference block 1030). The reference block 1508 may be used for the inter prediction of the block 1510 (e.g., motion estimation and/or motion compensation of the block 1510). The reference block 1508 may be associated with the reference frame 1502 (e.g., as shown in FIG. 10, the reference picture 1082 may include the reference block 1030).

Coding parameters associated with the reference frame 1502 may be stored, for example, using an IPM buffer 1512. The IPM buffer 1512 may be associated with the reference frame 1502. The IPM buffer 1512 may be associated with a resolution (e.g., a resolution of 4×4 basis as shown in FIG. 11). For example, a block or a subpart 1514, as shown in gray color, may be encoded or decoded using a certain intra-prediction mode (e.g., a planar intra-prediction mode, an intra-prediction mode 2, as shown in FIG. 11). An area 1516 (e.g., a block 1516 associated with the IPM buffer 1512) may correspond to the reference block 1508. The area 1516 may cover some 4×4 blocks or parts of some blocks associated with the IPM buffer. As an example, the area 1516 may cover a part of the block or subpart 1514. The intra-prediction mode that has been used to encode or decode the block or subpart 1514 may be determined as an intra-prediction mode that is to be used to encode or decode the block 1510, for example, if a left corner of the reference block 1508 or the left corner of the block 1510 is the pre-defined position associated with the determination for the intra-prediction mode that is to be used to encode or decode the block 1510.

A syntax element(s) may be inserted in the signaling, for example, to enable the decoder to identify an indication associated with performing 1300. For example, the syntax element may include an indication that indicate whether the intra-prediction mode used to decode the coding block is to be determined based on the intra-prediction mode information of the reference picture(s) (e.g., reference block(s)) associated with the inter-prediction mode, or the intra-prediction mode used to decode the coding block is to be a planar intra-prediction mode.

The syntax element(s) may be applied at the decoder. For example, the decoder may receive an indication that indicate whether the intra-prediction mode used to decode the coding block is to be determined based on the intra-prediction mode information of the reference picture(s) (e.g., reference block(s)) associated with the inter-prediction mode, or the intra-prediction mode used to decode the coding block is to be a planar intra-prediction mode. If the indication indicates that the intra-prediction mode used to decode the coding block is to be determined based on the intra-prediction mode information of the reference picture(s) associated with the inter-prediction mode, the decoder may perform 1300.

The encoder may adapt prediction residual based on one or more examples herein. A residual may be obtained, for example, by subtracting a predicted video block from the original image block. For example, the encoder may predict a coding block using the determined intra-prediction mode in one or more examples herein and an inter-prediction mode. The encoder may obtain the original image block and subtract the predicted coding block from the original image block to generate a prediction residual.

A bitstream or signal may include one or more of the described syntax elements, or variations thereof. For example, a bitstream or signal may include syntax element(s) that indicates whether the intra-prediction mode used to decode the coding block is to be determined based on the intra-prediction mode information of the reference picture(s) (e.g., reference block(s)) associated with the inter-prediction mode, or the intra-prediction mode used to decode the coding block is to be a planar intra-prediction mode and/or an indication of a parameter that the decoder uses to perform one or more examples herein.

A bitstream or signal may include syntax conveying information generated according to one or more examples herein. For example, information or data may be generated in performing the example as shown in FIG. 14. The generated information or data may be conveyed in syntax included in the bitstream or signal.

Syntax elements that enable the decoder to adapt a residue(s) in a manner corresponding to that used by an encoder may be inserted in a signal.

A method, process, apparatus, a TV, a set-top box, a cell phone, a tablet, medium storing instructions, medium storing data, a syntax element, a bitstream, or signal may be used for one or more of encoding, decoding, storing, displaying, transmitting, and/or receiving data according to one or more of the examples described herein. Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-31. (canceled)

32. A device for video decoding, comprising:
a processor configured to:
obtain a video block comprising an intra-prediction portion and an inter-prediction portion;
obtain a reference block in a reference picture of the video block;
determine an intra-prediction mode for the intra-prediction portion of the video block based on one or more intra-prediction modes associated with the reference block;
predict the intra-prediction portion of the video block using the intra-prediction mode;
predict the inter-prediction portion using an inter-prediction mode; and
decode the video block based on the intra-prediction portion and the inter-prediction portion of the video block.

33. The device of claim 32, wherein the processor is further configured to determine that geometric partitioning mode (GPM) is enabled for the video block, and wherein the intra-prediction portion and the inter-prediction portion are associated with GPM.

34. The device of claim 32, wherein the processor is further configured to:
determine an intra-prediction mode buffer of a plurality of intra-prediction mode buffers based on a type of intra-prediction mode associated with the reference picture of the video block, a picture order count difference associated with the reference picture of the video block, and a quantization parameter associated with the reference picture of the video block, and wherein the intra-prediction mode for the intra-prediction portion of the video block is determined based on the intra-prediction mode buffer.

35. The device of claim 32, wherein the processor is further configured to determine an intra-prediction mode buffer associated with the reference picture of the video block, the intra-prediction mode buffer comprises the one or more intra-prediction modes associated with the reference block, and the intra-prediction mode for the intra-prediction portion of the video block is determined using the intra-prediction mode buffer.

36. The device of claim 32, wherein the reference block comprises a reference sample, and wherein the one or more intra-prediction modes associated with the reference block comprises an intra-prediction mode associated with the reference sample.

37. The device of claim 32, wherein the reference block is associated with a plurality of intra-prediction modes, and the plurality of intra-prediction modes comprises an intra-prediction mode associated with a pre-defined position in the reference block, and wherein the intra-prediction mode for the intra-prediction portion of the video block is determined based on the intra-prediction mode associated with the pre-defined position in the reference block.

38. The device of claim 32, wherein the processor is further configured to receive an indication associated with an intra prediction of the video block, wherein the indication indicates that the intra-prediction mode for the intra-prediction portion of the video block is to be determined based on the one or more intra-prediction modes associated with the reference block, and wherein the intra-prediction mode for the intra-prediction portion of the video block is determined based on the indication.

39. A device for video encoding, comprising:
a processor configured to:
obtain a video block comprising an intra-prediction portion and an inter-prediction portion;
obtain a reference block in a reference picture of the video block;
determine an intra-prediction mode for the intra-prediction portion of the video block based on one or more intra-prediction modes associated with the reference block;
predict the intra-prediction portion of the video block using the intra-prediction mode;
predict the inter-prediction portion using an inter-prediction mode; and
encode the video block based on the intra-prediction portion and the inter-prediction portion of the video block.

40. The device of claim 39, wherein the processor is further configured to determine that geometric partitioning mode (GPM) is enabled for the video block, and wherein the intra-prediction portion and the inter-prediction portion are associated with GPM.

41. The device of claim 39, wherein the processor is further configured to:
determine an intra-prediction mode buffer of a plurality of intra-prediction mode buffers based on a type of intra-prediction mode associated with the reference picture of the video block, a picture order count difference associated with the reference picture of the video block, and a quantization parameter associated with the reference picture of the video block, and wherein the intra-prediction mode for the intra-prediction portion of the video block is determined based on the intra-prediction mode buffer.

42. The device of claim 39, wherein the processor is further configured to determine an intra-prediction mode buffer associated with the reference picture of the video block, the intra-prediction mode buffer comprises the one or more intra-prediction modes associated with the reference block, and the intra-prediction mode for the intra-prediction portion of the video block is determined using the intra-prediction mode buffer.

43. The device of claim 39, wherein the reference block comprises a reference sample, and wherein the one or more intra-prediction modes associated with the reference block comprises an intra-prediction mode associated with the reference sample.

44. A method for video decoding, comprising:
obtaining a video block comprising an intra-prediction portion and an inter-prediction portion;
obtaining a reference block in a reference picture of the video block;
determining an intra-prediction mode for the intra-prediction portion of the video block based on one or more intra-prediction modes associated with the reference block;
predicting the intra-prediction portion of the video block using the intra-prediction mode;
predicting the inter-prediction portion using an inter-prediction mode; and
decoding the video block based on the intra-prediction portion and the inter-prediction portion of the video block.

45. The method of claim 44, further comprising determining that geometric partitioning mode (GPM) is enabled for the video block, and wherein the intra-prediction portion and the inter-prediction portion are associated with GPM.

46. The method of claim 44, and the method comprises:
determining an intra-prediction mode buffer of a plurality of intra-prediction mode buffers based on a type of intra-prediction mode associated with the reference picture of the video block, a picture order count difference associated with the reference picture of the video block, and a quantization parameter associated with the reference picture of the video block, and wherein the intra-prediction mode for the intra-prediction portion of the video block is determined based on the intra-prediction mode buffer.

47. The method of claim 44, wherein the method comprises determining an intra-prediction mode buffer associated with the reference picture of the video block, the intra-prediction mode buffer comprises the one or more intra-prediction modes associated with the reference block, and the intra-prediction mode for the intra-prediction portion of the video block is determined using the intra-prediction mode buffer.

48. A method for video encoding, comprising:
obtaining a video block comprising an intra-prediction portion and an inter-prediction portion;
obtaining a reference block in a reference picture of the video block;
determining an intra-prediction mode for the intra-prediction portion of the video block based on one or more intra-prediction modes associated with the reference block;
predicting the intra-prediction portion of the video block using the intra-prediction mode;
predicting the inter-prediction portion using an inter-prediction mode; and
encoding the video block based on the intra-prediction portion and the inter-prediction portion of the video block.

49. The method of claim 48, further comprising determining that geometric partitioning mode (GPM) is enabled for the video block, and wherein the intra-prediction portion and the inter-prediction portion are associated with GPM.

50. The method of claim 48, and the method comprises:
determining an intra-prediction mode buffer of a plurality of intra-prediction mode buffers based on a type of intra-prediction mode associated with the reference picture of the video block, a picture order count difference associated with the reference picture of the video block, and a quantization parameter associated with the reference picture of the video block, and wherein the intra-prediction mode for the intra-prediction portion of the video block is determined based on the intra-prediction mode buffer.

51. The method of claim 48, wherein the method comprises determining an intra-prediction mode buffer associated with the reference picture of the video block, the intra-prediction mode buffer comprises the one or more intra-prediction modes associated with the reference block, and the intra-prediction mode for the intra-prediction portion of the video block is determined using the intra-prediction mode buffer.
